(19) United States
(12) Patent Application Publication
(10) Pub. No.: US 2006/0147141 A1
(43) Pub. Date: Jul. 6, 2006

(54) Combination labyrinth and lip seal for idler rollers

(76) Inventors: William B. Harwood, Guntown, MS (US); Thomas M. Gusmus, Guntown, MS (US); Angel I. Segura, Cordoba (AR); Randy K. Baird, Bolivar, PA (US); Robert A. Kershaw, Edmonton (CA)

Correspondence Address: WILLIAMS, MORGAN & AMERSON, 10333 RICHMOND, SUITE 1100, HOUSTON, TX, 77042, US

(21) Appl. No.: 11/257,734

(22) Filed: Oct. 25, 2005

Related U.S. Application Data
(60) Provisional application No. 60/623,508, filed on Oct. 29, 2004.

(51) Int. Cl. F16C 33/80

(52) U.S. Cl. 384/480

(57) ABSTRACT

An idler roller is disclosed which includes a non-rotating shaft, a roller shell positioned around the non-rotating shaft and a bearing assembly proximate each end of the roller shell. The bearing assembly includes an outer labyrinth member and an inner labyrinth member having an integrally formed shaft seal, wherein the inner and outer labyrinth members define a labyrinth seal and the integrally formed shaft seal sealingly engages an outer surface of the non-rotating shaft.

### CROSS-REFERENCE TO RELATED APPLICATIONS

The present application claims priority to U.S. Provisional Patent Application Ser. No. 60/623,508 filed Oct. 29, 2004, the entire contents of which is specifically incorporated herein by reference in its entirety.

### BACKGROUND OF THE INVENTION

1. Field of the Invention

The present invention relates to a bearing seal assembly for idler rollers, and, more specifically, to a bearing seal assembly for idler rollers for bulk material belt conveyors. An example of this type of belt conveyor system is described in U.S. Pat. No. 6,516,942, the entirely of which is hereby incorporated herein by reference for all purposes.

2. Description of the Related Art

Typical idler rollers include seal components that protect the bearing from the ingress of contaminants. The traditional location for these seal components is adjacent to the bearings within the same bore between the bearings and the outside environment. The thickness of these seal elements requires the bearings to be placed deeper inside the roller. This increases the leverage distance from the bearings to the shaft supports, which causes increased shaft defection and reduced bearing life.

The load rating of idler rollers is typically the main criteria for selecting a particular roller for a particular application. The load rating is how much load the roller can withstand and still perform satisfactorily over its expected life. The load rating of the bearings largely determines the load rating of the idler roller, but idler roller load rating is also dependent on how the bearings are mounted with respect to the shaft supports. Shafts that are supported at the ends are bowed or deflected by the load when the bearings are mounted inboard of the roller ends. The farther away the bearings are from the shaft supports, the greater the shaft deflection. This shaft deflection diminishes the load rating of the bearing, and consequently causes the idler roller to have a smaller load rating. Moving the bearing outward toward the shaft supports will decrease this deflection and increase the idler load rating.

However, there is a limit to how much the bearing can be moved outward on the shaft to be closer to the shaft supports to reduce the shaft deflection. A supplemental seal is typically inserted between the bearing mounted inside the roller and the outside environment where the shaft supports are located. The thickness or depth of this seal determines how deep the bearing must be moved inward to allow space for this seal. Thus, a thinner seal will allow the bearings to be mounted closer to the shaft support. Thus, a problem to be solved is to develop a very thin seal in order to allow the bearings to be moved farther outboard, i.e., closer to the supports. This must be accomplished without any reduction in sealing effectiveness.

In particularly harsh environments, such as the tar sands (or oil sands) mines of northern Alberta, Canada, end users of this type of roller typically demand in their specifications that labyrinth type seals be used in all rollers. The environment in which these rollers operate is very harsh, and abrasive material has a tendency to work its way inward through the seals of the rollers, eventually causing catastrophic failure of the rollers. In order to prevent material build-up on the belts, a mixture of water and glycol may be used to spray the spilled material off the belts in certain locations. However, this liquid spray poses an additional risk of failure of the seal elements.

The present invention is directed to various methods for solving, or at least reducing the effects of, some or all of the aforementioned problems.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one illustrative embodiment, an idler roller is disclosed which includes a non-rotating shaft, a roller shell positioned around the non-rotating shaft and a bearing assembly proximate each end of the roller shell. The bearing assembly includes an outer labyrinth member and an inner labyrinth member having an integrally formed shaft seal, wherein the inner and outer labyrinth members define a labyrinth seal and the integrally formed shaft seal sealingly engages an outer surface of the non-rotating shaft.

In a further exemplary embodiment, the inner labyrinth member is pressed into the bearing housing of the roller, and the outer labyrinth member is pressed onto the shaft of the roller. Once assembled, the inner and outer members cooperate to form a horizontal labyrinth seal. In more detailed embodiments, the outer labyrinth member may be made of polyurethane integrally molded around a metal retaining ring, and the inner labyrinth member may be made of nitrile rubber integrally molded into a steel casing.

In one very specific embodiment, the inner labyrinth member further includes two radially extending lip seals that contact the outside diameter of the roller shaft. The dual lip seals provide an additional barrier to the ingress of contaminants. The combination of a labyrinth and a shaft seal in a single member provides many advantages. This type of seal has particular utility in harsh, abrasive environments, such as the above-mentioned tar sand mines, and it may be employed in other environments and in other bearing or roller types.

### BRIEF DESCRIPTION OF THE DRAWINGS

The invention may be understood by reference to the following description taken in conjunction with the accompanying drawings, in which like reference numerals identify like elements, and in which:

FIG. 1 is a cross-sectional view of the end portion of an idler roller incorporating a first possible embodiment of the invention;

FIG. 1a is a close-up cross-sectional view of the seal assembly shown in FIG. 1;

FIGS. 1b and 1c depict illustrative alternative embodiments for the outer labyrinth member disclosed herein;

FIGS. 2-4 are, respectively, perspective, front and back views of the inner labyrinth member shown in FIG. 1;

FIGS. 5-7 are, respectively, perspective, front and back views of the outer labyrinth member shown in FIG. 1;

FIG. 8 is a cross-sectional view of the end portion of an idler roller incorporating a second possible embodiment of the invention;

FIG. 8a is a close-up cross-sectional view of the seal assembly shown in FIG. 8;

FIG. 9 is a cross-sectional view of the end portion of an idler roller incorporating a third possible embodiment of the invention;

FIG. 9a is a close-up cross-sectional view of the seal assembly shown in FIG. 9;

FIGS. 10-11 are perspective views of the bearing and inner labyrinth seal installed in the bearing housing shown in FIG. 9;

FIGS. 12-13 are, respectively, a front view and a back oblique view of the outer labyrinth member shown in FIG. 9;

FIGS. 14-15 are, respectively, a perspective and side view of the rubber lip seal member shown in FIG. 9;

FIG. 16 is a front perspective view of the rubber lip seal member installed on the outer labyrinth member shown in FIG. 9; and

FIG. 17 is a rear perspective view of the outer labyrinth member installed in the bearing housing shown in FIG. 9.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

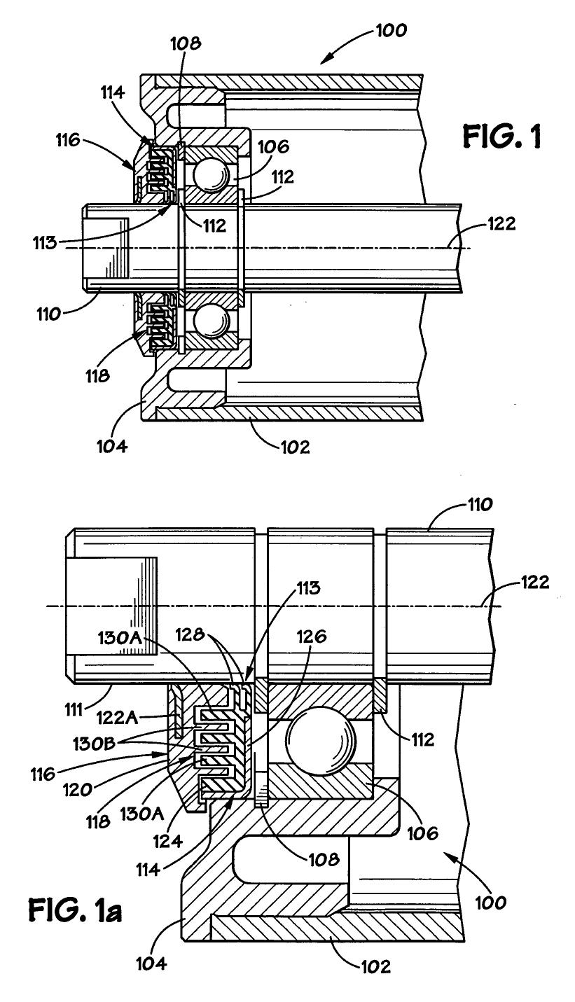

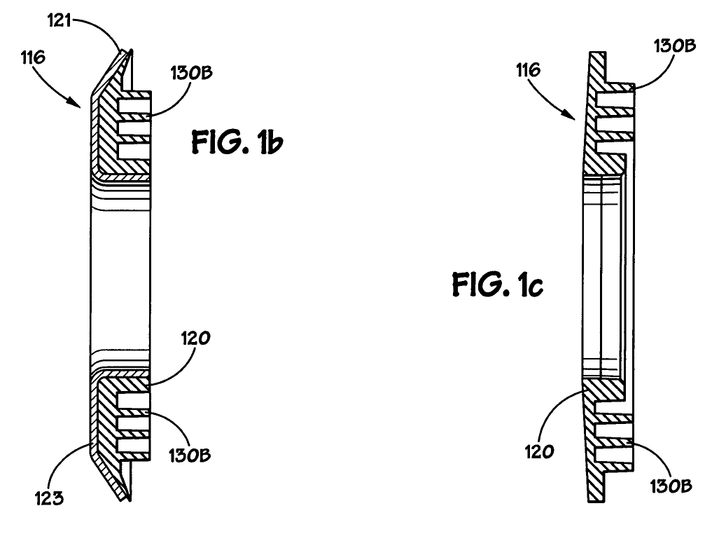

Referring to FIGS. 1 and 1a, an idler roller 100 for a belt conveyor system comprises a rotating tubular roller shell 102, and a bearing housing 104 that is operatively coupled to the roller shell 102. In one illustrative embodiment, the bearing housing 104 may be press-fit into the roller shell 102. The bearing housing 104 may also be operatively coupled to the end of the shell 102 by other means, such as welding. The bearing housing 104 may be made of a variety of materials, such as, for example, ductile iron or any other suitable material. A bearing 106 is retained in the bearing housing 104 by a retaining ring 108. The bearing 106 is further retained on the non-rotating shaft 110 of the roller 100 by a plurality of by retaining rings 112. In one exemplary embodiment, the seal assembly of the present invention comprises two members or subcomponents, an inner labyrinth member 114 and an outer labyrinth member 116. In one illustrative embodiment, the inner labyrinth member 114 is press-fit into the bearing housing 104, and the outer labyrinth member 116 is press-fit onto the shaft 110. Of course, other methods of attachment may also be employed. Any suitable materials and methods of construction may be used for the inner and outer labyrinth members 114, 116.

Once assembled, axially extending legs on both the inner labyrinth member 114 and the outer labyrinth member 116 cooperate to form a labyrinth seal 118, in a manner which is well known in the art. The labyrinth portion of the seal uses centrifugal forces and tight labyrinth gaps to prevent solids and liquids from impinging upon the lip seals. In the illustrative embodiment depicted herein, a 7-gap labyrinth seal is disclosed. However, after a complete reading of the present application, those skilled in the art will understand that the labyrinth seal 118 may have a greater or smaller number of gaps as compared to the illustrative 7-gap configuration depicted herein.

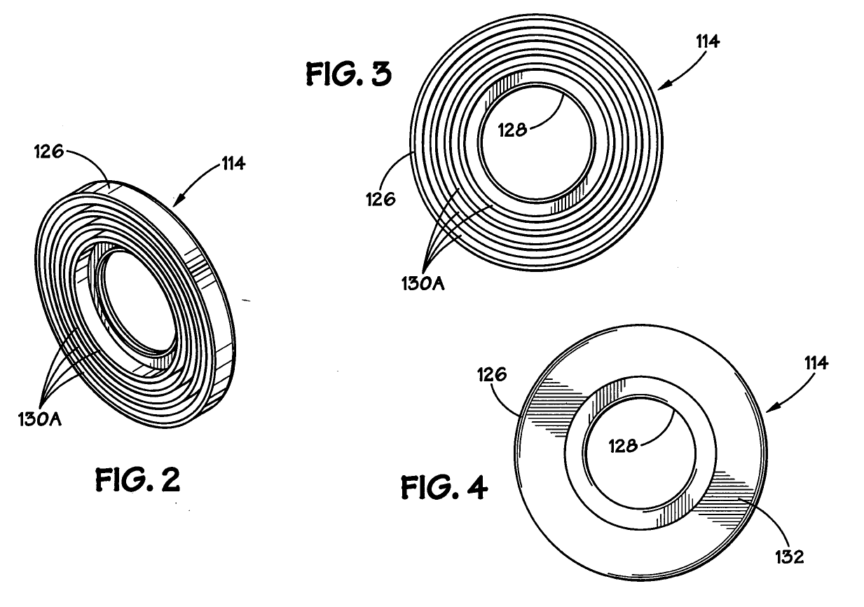

In one illustrative embodiment, the inner labyrinth member 114 comprises a relatively soft sealing member and a relatively strong structural member. For example, the inner labyrinth member 114 may comprise a nitrile rubber body 124 that is integrally molded into a steel casing 126. Of course, other materials may also be employed. Various views of one illustrative embodiment of the inner labyrinth member 114 are shown in FIGS. 2-4. FIGS. 2, 3 and 4 are, respectively, perspective, front and back views of the inner labyrinth member 114. As shown in FIGS. 2 and 3, the inner labyrinth member 114 comprises a plurality of axial protrusions 130A that will form part of the labyrinth seal 118. FIG. 4 depicts the back side 132 of the steel casing 126.

In the illustrative embodiment depicted herein, the inner labyrinth member 114 further comprises means for sealing to the outer surface 111 of the shaft 110. More specifically, the inner labyrinth member 114 comprises an integrally formed shaft seal 113 that is adapted to sealingly engage the outer surface 111 of the shaft 110. In the illustrative embodiment depicted herein, the shaft seal 113 comprises two radially extending lip seals 128 which contact and seal to the outside diameter 111 of the roller shaft 110. The lip seals 128 and rubber body 124 are all formed as an integral unit that is molded to the steel casing 126. Labyrinth seals have been proven effective in excluding solid contaminants, but, over time will allow liquids to leak through. In the illustrative example disclosed herein, the illustrative dual lip seals 128 on the inner labyrinth member 114, which are positioned inward of the labyrinth seal 118, provide an additional barrier to the ingress of contaminants. Incorporating the shaft seal 113, e.g., the lip seals 128, on the inner labyrinth member 114 also minimizes the amount of axial space required between the outer end of the bearing housing 104 and the bearing 106. That is, positioning the shaft seal 113, e.g., the lip seals 128, within the axial space or width occupied by the inner labyrinth member 114 permits the bearing to be placed closer to the shaft support. This permits the bearing 106 to be placed closer to the shaft support (not shown), thereby providing a more stable arrangement. Furthermore, by positioning the lip seals 128 such that they seal to the outside diameter 111 of the non-rotating roller shaft 110, the drag torque the seals 128 impart to the roller 100 is decreased, as compared to other designs in which the lip seals seal to the bearing housing 104. This is because the drag torque is proportional to the radial distance from the seal contact point to the roller centerline 122. This distance is greater for seals which seal to the roller housing 104, rather than to the outside diameter 111 of the shaft 110. Although two illustrative lip seals 128 are depicted, after a complete reading of the present application, those skilled in the art will understand that any number of lip seals 128 could be provided. For example, a single lip seal 128 may be employed.

It has been the practice of many belt conveyor idler manufacturers in the past to use both labyrinth and contact seals in various forms and configurations. The seal of the present invention is unique in that, in one embodiment, the dual lip shaft contact seals 128 are formed as an integral part of the inner labyrinth member 114. In the present invention, incorporating the shaft seal 113, e.g., the lip seals 128, into the inner labyrinth member 114 also decreases the number of components in the seal assembly, thus decreasing the amount of time required to assemble the seal and the roller.

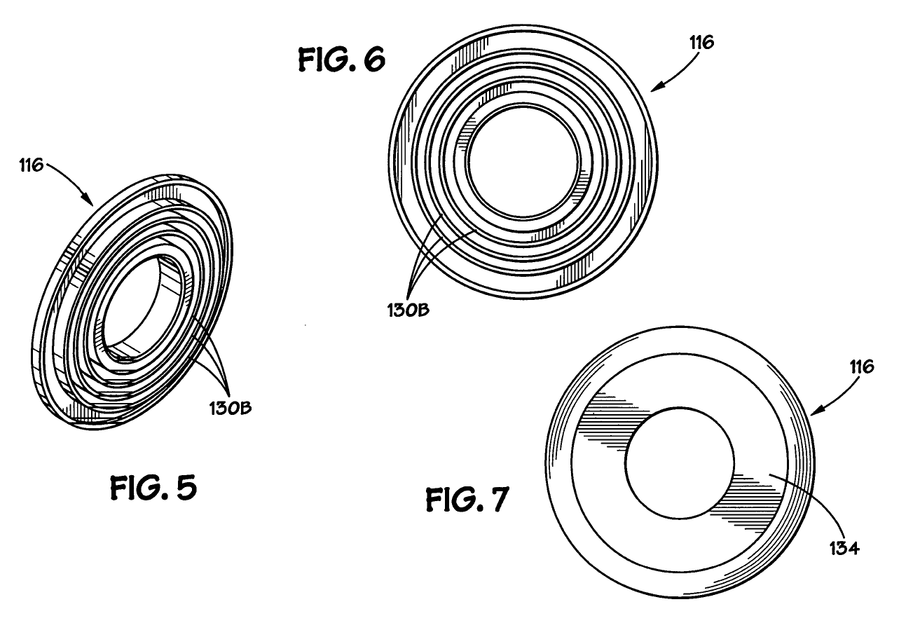

In one illustrative embodiment, the outer labyrinth member 116 may comprise a polyurethane body 120 integrally molded around a metal retaining ring 122A. Various views of the illustrative outer labyrinth member 116 are shown in FIGS. 5-7. FIGS. 5, 6 and 7 are, respectively, perspective, front and end views of the outer labyrinth member 116. As shown in FIGS. 5 and 6, the outer labyrinth member 116 comprises a plurality of axial protrusions 130B that cooperate with the axial protrusions 130A on the inner labyrinth member 114 to define the labyrinth seal 118. The outer labyrinth member 116 has an outer surface 134.

FIG. 1b depicts an alternative embodiment of the outer labyrinth member 116. In this embodiment, the metal retaining ring 122 is replaced with an outer structural member 123 in which the polyurethane body 120 is positioned. The member 123 engages the outer surface 111 of the shaft 110. In some embodiments, the end 121 of the member 123 may be sized and configured to actually engage the face of the bearing housing 104 so as to provide a weather seal. FIG. 1c depicts yet another illustrative embodiment of the outer labyrinth member 116. In this embodiment, the outer labyrinth member 116 is comprised entirely of a plastic material. Such an embodiment may be employed in certain applications where lower rolling resistance is required. The outer labyrinth seal member 116 depicted in FIG. 1c may also be press-fit onto the shaft 110. Other forms of attachment are also possible.

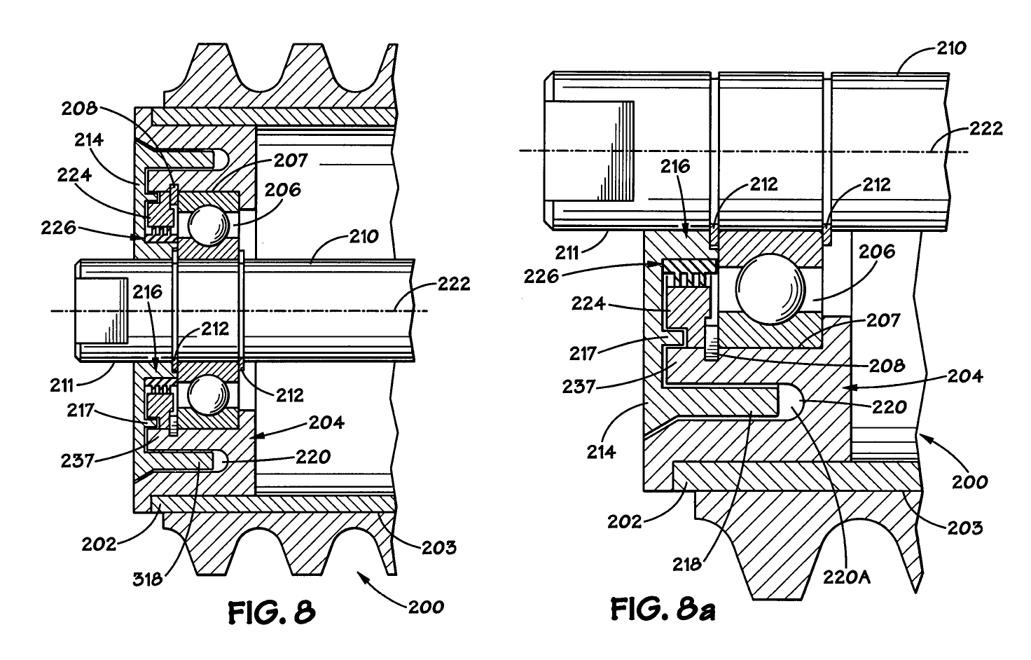

Referring to FIGS. 8 and 8a, in a second exemplary embodiment, an idler roller 200 for a belt conveyor system comprises a rotating tubular roller shell 202, and a bearing housing 204 press-fit into or otherwise suitably attached to the end of the shell 202. The bearing housing 204 may be made of ductile iron or any other suitable material. A bearing 206 is retained in the bearing housing 202 by a retaining ring 208. The bearing 206 is further retained on the non-rotating shaft 210 of the roller 200 by retaining rings 212.

In this exemplary embodiment, the bearing seal assembly of the present invention comprises three members. An outer labyrinth seal member 214 comprises a first axially extending leg portion 216 which is press-fit onto the outside diameter 211 of the shaft 210. The outer labyrinth member 214 may be precision machined from steel or any other suitable material. Alternatively, member 214 could comprise a die casting of zinc or any other suitable material. The outer labyrinth seal member 214 also comprises a second axially extending center leg portion 217, which is disposed radially outwardly of the first leg portion 216, and an elongated, axially extending leg portion 218, which is disposed radially outwardly of the center leg portion 217. The bearing housing 204 further comprises an axially extending groove 220, which receives the elongated leg portion 218 when the seal is assembled. In one illustrative embodiment, the groove 220 may have a depth of approximately 1.4 inches. A pocket or chamber 220A is provided at the end of the groove 220. The chamber 220A may provide space for the accumulation of contaminants that could eventually pass the first labyrinth run, thereby reducing the likelihood of such contaminants progressing toward the bearing.

The leg portion 218 and the groove 220 cooperate to form a deep labyrinth seal which provides protection against contaminants. Depending on the particular application, the centerline of the leg portion 218 may be positioned approximately 2-3.5 inches from the centerline of the shaft 210. Expressed as a ratio, the radial spacing of the centerline of the shaft 210 may range from approximately 0.65-0.80. By positioning the leg portion 218 and the groove 220 of the labyrinth seal proximate to the outside diameter 203 of the roller 200, the seal takes advantage of the larger centrifugal forces present at positions radially distant from the centerline 222 of the shaft 210 of the roller 200. Also note that, due to the length of the leg 218 and the depth of the recess 220, the outer labyrinth axially overlaps at least a portion of the axial width of the bearing. In one embodiment, the axial overlap may be greater than 50% of the axial width of the bearing. Such a configuration provides a compact seal bearing assembly with a relatively long labyrinth that may improve seal life and performance.

An internal seal race 224 is disposed within the inside diameter 235 of the bearing housing 204. The seal race 224 may be precision machined from steel or any other suitable material. Alternatively, the seal race 224 could comprise a die casting of zinc or any other suitable material. In one illustrative embodiment, a triple-lip nitrile rubber contact seal element 226 is disposed between the internal seal race 224 and the first leg portion 216 of the outer labyrinth seal member 214. Of course, the number of lips 331 on the seal element 226 may vary depending upon the particular application. By positioning the labyrinth and contact seals concentrically, rather than spacing them axially, the bearing 206 can be positioned closer to the shaft support (not shown). As discussed above, this may increase the load rating of the roller 200. The center leg portion 217 is positioned between the seal race 224 and a portion 237 of the bearing housing 204. In this embodiment, the lips 331 seal against the seal race 224 as compared to the embodiment shown in FIG. I a wherein the lip seals 128 seal against the outer diameter of the shaft.

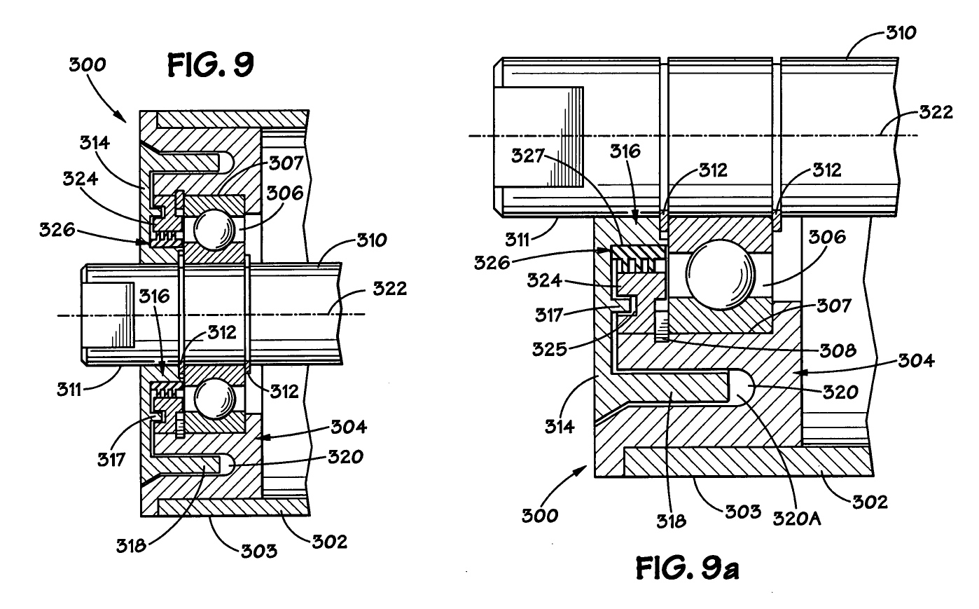

Referring to FIGS. 9 and 9a, a third exemplary embodiment is substantially similar to the embodiment shown in FIGS. 8 and 8a. In this third exemplary embodiment, an idler roller 300 for a belt conveyor system comprises a rotating tubular roller shell 302, and a bearing housing 304 that press-fit into or otherwise suitably attached to the end of the shell 302. The bearing housing 304 may be made of ductile iron or any other suitable material. A bearing 306 is retained in the bearing housing 304 and on a non-rotating shaft 310 by retaining rings 312, in a manner similar to the previous embodiment.

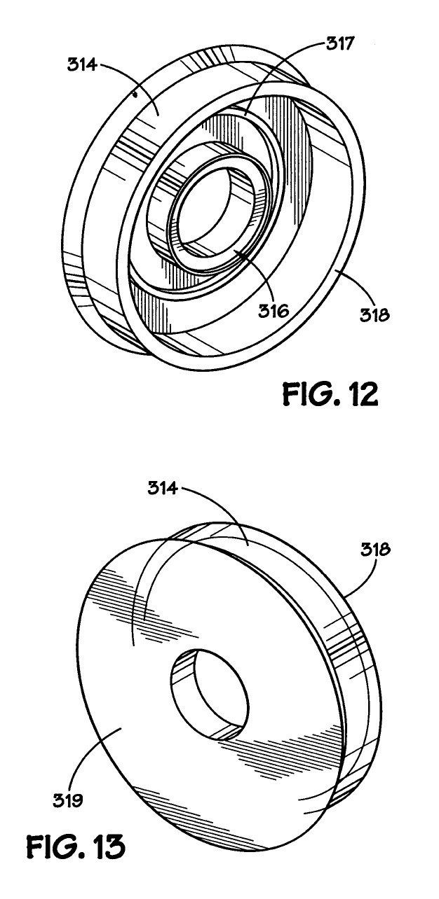

In this third exemplary embodiment, the bearing seal assembly of the present invention comprises three members. An outer labyrinth seal member 314 comprises an axially extending inner leg portion 316 which is press-fit onto the outside diameter 311 of the shaft 310. The outer labyrinth member 314 may be precision machined from steel or any other suitable material. Making the outer labyrinth member 314 out of steel allows precise control of gap clearance. Alternatively, the outer labyrinth member 314 could comprise a die casting of zinc or any other suitable material. The outer labyrinth seal member 314 also comprises an axially extending center leg portion 317, which is disposed radially outwardly of the inner leg portion 316. The outer labyrinth seal member 314 further comprises an elongated axially extending outer leg portion 318, which is disposed radially outwardly of the center leg portion 317. FIGS. 12 and 13 are, respectively, a front view and an oblique end view of the outer labyrinth seal member 314. The back surface 319 of the outer labyrinth seal member 314 is shown in FIG. 13.

The bearing housing 304 further comprises an axially extending outer groove 320, which receives the outer leg portion 318 when the seal is assembled. The outer leg portion 318 and the outer groove 320 cooperate to form a deep labyrinth seal which provides protection against contaminants. A pocket 320A may be provided as well for purposes similar to that described above with respect to the pocket 220A. The depth of the groove 320 may be substantially the same as that of the groove 220 described above. By positioning the leg portion 318 and the groove 320 of the labyrinth seal proximate to the outside diameter 303 of the roller 300, the seal takes advantage of the larger centrifugal forces present at positions radially distant from the centerline 322 of the roller 300. This unique labyrinth placement also allows the labyrinth channels to be substantially longer (up to two times longer) than those in existing idler roller seals. This extended channel length is expected to radically improve the effectiveness of the labyrinth seals. FIG. 17 is a drawing depicting the outer labyrinth seal member 314 and the bearing housing 304 assembled together.

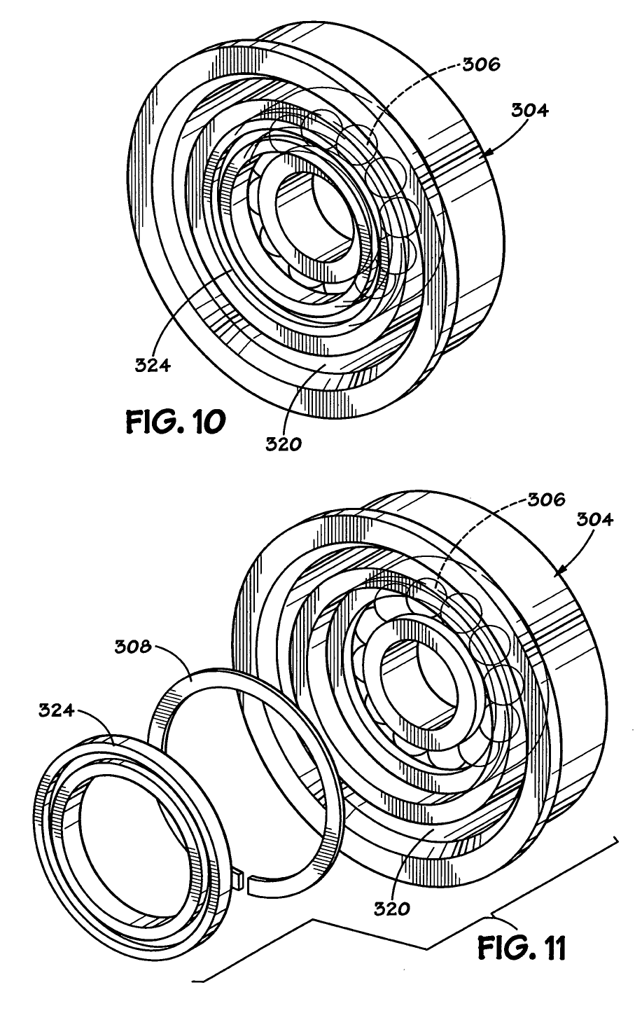

A seal race member 324 is press-fit into the bearing housing 304 of the roller 300. In the illustrative embodiment depicted in FIGS. 9 and 9a, the seal race member 324 comprises a central groove 325, which cooperates with the center leg 317 of the outer labyrinth member 314 to create a secondary labyrinth seal. The seal race member 324 is also referred to as an inner labyrinth seal member. Preferably, the seal race 324 is made out of steel, but in other embodiments any suitable material may be used. FIGS. 10 and 11 are drawings of the bearing 306 and seal race 324 (inner labyrinth seal member) installed in the bearing housing 304.

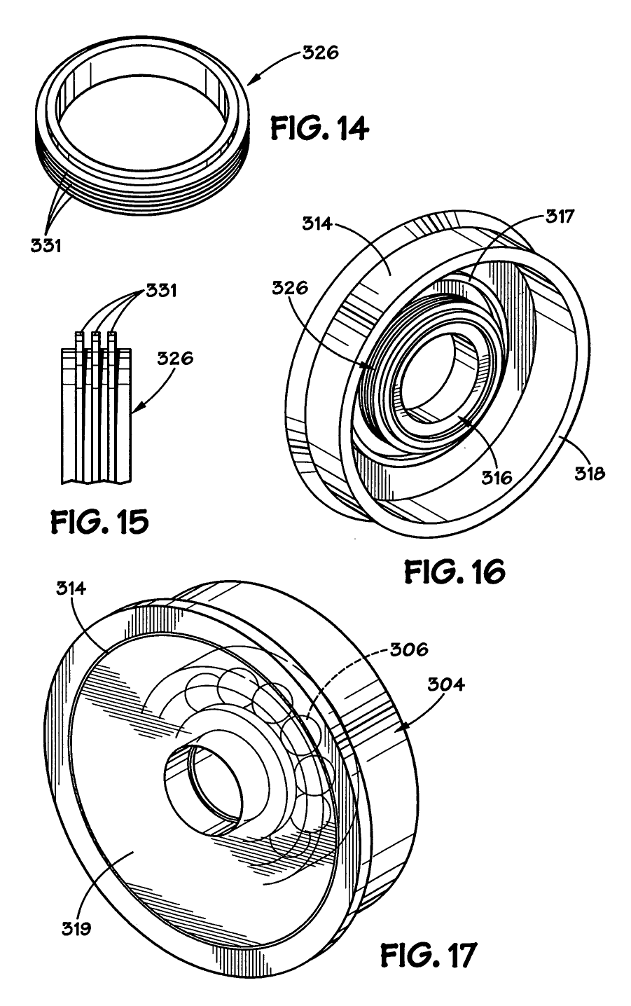

In one illustrative embodiment, a three-lip rubber contact seal 326 is mounted around the inner leg 316 of the outer labyrinth member 314, and is held there via a tight fit. Three radially extending sealing lips 331 seal against the inside diameter surface 327 of the seal race 324 to form a third seal against contaminants (after the first and second labyrinth seals). FIGS. 14 and 15 are, respectively, perspective and side views of the lip seal element 326. In the illustrative embodiment depicted in FIG. 15, the lip seal member 326 comprises three radially extending lips 331. Of course, the number of lips 331 on the seal element 326 may vary depending upon the particular application. FIG. 16 is a drawing of the lip seal element 326 installed on the outer labyrinth member 314. In this embodiment, the lips 331 also seal against the race 324 as compared to sealing against the shaft 310.

This proposed seal arrangement takes advantage of the excess space between the bearing outside diameter 307 and the roller shell 302, which is present in virtually all roller designs. By placing the main labyrinth seal in this space, rather than outboard of the bearings 306 along the shaft 310, the bearings 306 can be located closer to the shaft supports (not shown). As discussed above, this reduces shaft deflection, thereby increasing bearing life. An additional advantage is that by placing the labyrinth seal farther from the shaft centerline 322, the seal is subjected to greater centrifugal forces, making the seal more effective against the ingress of contaminants. As with the embodiment depicted in FIGS. 8a-8b, in the embodiment shown in FIGS. 9a-9b, a chamber 320a is provided and the outer leg 318 may be radially positioned from the shaft 310 in a similar fashion to that described above for the location of the leg portion 218 relative to the centerline of the shaft 210. Additionally, in some embodiments, the labyrinth may axially overlap the axial width of the bearing as described previously for the embodiment depicted in FIGS. 8a-8b.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An idler roller, comprising:
a non-rotating shaft;
a roller shell positioned around said non-rotating shaft; and
a bearing assembly proximate each end of said roller shell, said bearing assembly comprising:
an outer labyrinth member; and
an inner labyrinth member comprising an integrally formed shaft seal, wherein said inner and outer labyrinth members define a labyrinth seal and said integrally formed shaft seal sealingly engages an outer surface of said non-rotating shaft.

2. The idler roller of claim 1, wherein said inner and outer labyrinth members define a labyrinth seal comprising seven gaps.

3. The idler roller of claim 1, wherein said shaft seal comprises at least one lip seal.

4. The idler roller of claim 1, wherein said shaft seal comprises two lip seals, each of which are adapted to sealingly engage said outer surface of said non-rotating shaft.

5. The idler roller of claim 1, wherein said shaft seal is positioned within an axial width occupied by said inner labyrinth member.

6. The idler roller of claim 1, wherein said outer labyrinth member is press-fit onto said non-rotating shaft.

7. The idler roller of claim 1, wherein said shaft seal is positioned inward of said labyrinth seal.

8. The idler roller of claim 1, wherein said bearing assembly further comprises a bearing housing that is operatively coupled to said roller shell.

9. The idler roller of claim 8, wherein said bearing housing is in a press-fit engagement with said roller shell.

10. The idler roller of claim 8, wherein said inner labyrinth member is at least partially positioned within said bearing housing.

11. The idler roller of claim 8, wherein said inner labyrinth member is in a press-fit engagement with said bearing housing.

12. The idler roller of claim 1, wherein said labyrinth member is comprised of a nitrile rubber and a metal casing.

13. The idler roller of claim 1, wherein said outer labyrinth member comprises polyurethane.

14. An idler roller, comprising:
a non-rotating shaft;
a roller shell positioned around said non-rotating shaft; and
a bearing assembly proximate each end of said roller shell, said bearing assembly comprising:
an outer labyrinth member; and
an inner labyrinth member comprising at least one integrally formed lip seal, wherein said inner and outer labyrinth members define a labyrinth seal and said at least one lip seal sealingly engages an outer surface of said non-rotating shaft.

15. The idler roller of claim 14, wherein said at least one integrally formed lip seal is positioned within an axial width occupied by said inner labyrinth member.

16. The idler roller of claim 14, wherein said inner labyrinth seal comprises two lip seals, each of which are adapted to sealingly engage said outer surface of said non-rotating shaft.

17. The idler roller of claim 16, wherein said two lip seals are positioned within an axial width occupied by said inner labyrinth member.

18. The idler roller of claim 14, wherein said bearing assembly further comprises a bearing housing that is operatively coupled to said roller shell.

19. An idler roller, comprising:
a non-rotating shaft;
a roller shell positioned around said non-rotating shaft; and
a bearing assembly proximate each end of said roller shell, said bearing assembly comprising:
a bearing housing that is operatively coupled to said roller shell;
an outer labyrinth member that is press-fit onto said non-rotating shaft; and
an inner labyrinth member comprising an integrally formed shaft seal, wherein said inner and outer labyrinth members define a labyrinth seal and said shaft seal sealingly engages an outer surface of said non-rotating shaft, and wherein said inner labyrinth member is in a press-fit engagement with said bearing housing.

20. The idler roller of claim 19, wherein said shaft seal comprises at least one lip seal.

21. The idler roller of claim 19, wherein said shaft seal comprises two lip seals, each of which are adapted to sealingly engage said outer surface of said non-rotating shaft.

22. The idler roller of claim 19, wherein said shaft seal is positioned within an axial width occupied by said inner labyrinth member.

23. The idler roller of claim 19, wherein said bearing housing is in a press-fit engagement with said roller shell.

24. An idler roller, comprising:
a non-rotating shaft;
a roller shell positioned around said non-rotating shaft; and
a bearing assembly proximate each end of said roller shell, said bearing assembly comprising:
an outer labyrinth member; and
an inner labyrinth member comprising two integrally formed lip seals positioned within an axial width occupied by said inner labyrinth member, wherein said inner and outer labyrinth members define a labyrinth seal and each of said at least two lip seals sealingly engage an outer surface of said non-rotating shaft.

25. The idler roller of claim 24, wherein said bearing assembly further comprises a bearing housing that is operatively coupled to said roller shell.

26. The idler roller of claim 25, wherein said bearing housing is in a press-fit engagement with said roller shell.

27. The idler roller of claim 25, wherein said inner labyrinth member is in a press-fit engagement with said bearing housing.
